(19) United States
(12) Patent Application Publication
(10) Pub. No.: US 2013/0130115 A1
(43) Pub. Date: May 23, 2013

(54) COMPOSITE NEGATIVE ACTIVE MATERIAL, METHOD OF PREPARING THE SAME, AND LITHIUM SECONDARY BATTERY INCLUDING THE SAME

(71) Applicants: Jin-hwan PARK, Seoul (KR); Dongmok WHANG, Suwon-si (KR); Sun-hwak WOO, Suwon-si (KR)

(72) Inventors: Jin-hwan PARK, Seoul (KR); Dongmok WHANG, Suwon-si (KR); Sun-hwak WOO, Suwon-si (KR)

(73) Assignee: SAMSUNG ELECTRONICS CO., LTD., Suwon-si (KR)

(21) Appl. No.: 13/484,025

(22) Filed: May 30, 2012

(30) Foreign Application Priority Data
Nov. 22, 2011 (KR) 10-2011-0122392

(51) Int. Cl. H01M 4/583; H01M 4/04; B82Y 40/00; B82Y 30/00

(52) U.S. Cl. 429/231.8; 216/13; 252/182.1; 977/888; 977/890; 977/948

(57) ABSTRACT

A composite negative active material including metal nanostructures disposed on one or more of a surface and inner pores of a porous carbon-based material, a method of preparing the material, and a lithium secondary battery including the material.

### CROSS-REFERENCE TO RELATED APPLICATION

This application claims the benefit of Korean Application No. 10-2011-0122392, filed on Nov. 22, 2011 in the Korean Intellectual Property Office, the disclosure of which is incorporated herein by reference.

### BACKGROUND

1. Field

Aspects of the present invention relate to a composite negative active material, a method of preparing the same, and a lithium secondary battery including the same, and more particularly, to a composite negative active material with improved lifetime characteristics, a method of preparing the same, and a lithium secondary battery including the same.

2. Description of the Related Art

Lithium secondary batteries used in portable electronic devices for information and telecommunication, such as a personal digital assistant (PDA), a mobile phone, and a notebook computer, or an electric bicycle and an electric vehicle, have discharge voltages that are twice or more higher than those of general batteries, and as a result, lithium secondary batteries may exhibit high energy densities.

In a state of charging an organic electrolyte or a polymer electrolyte between a positive electrode and a negative electrode including active materials capable of having lithium ions intercalated therein and deintercalated therefrom, a lithium secondary battery generates electrical energy via oxidation and reduction reactions in which lithium ions are intercalated into and deintercalated from the positive electrode and the negative electrode, respectively.

Exemplary embodiments of a positive active material for a lithium secondary battery may be oxides including lithium and transition metals and having a structure enabling intercalation of lithium ions such as lithium cobalt oxide (LiCoO₂), lithium nickel oxide (LiNiO₂), or lithium nickel cobalt manganese oxides (Li[NiCoMn]O₂ and Li[Ni_{1-x-y}CoₓMn_{y}]O₂).

Various carbon-based materials including artificial graphite, natural graphite, or hard carbon, which are capable of having lithium ions intercalated therein and deintercalated therefrom, are used as a negative active material. However, when a negative electrode plate is prepared by using graphite, such as artificial graphite or natural graphite, as an active material among the carbon-based materials, a capacity thereof may be low in terms of energy density per unit volume of the negative electrode plate due to a low plate density of the negative electrode.

Also, a non-carbon-based material such as silicon (Si) has a density capacity of 10 times or more in comparison to that of graphite and may exhibit a very high capacity. However, cycle lifetime characteristics of the non-carbon-based material may degrade due to volume expansion and contraction thereof during lithium charge and discharge.

Therefore, there is a need to develop a negative active material, such as Si, where lifetime characteristics thereof are improved by minimizing stress due to the volume expansion and contraction of the non-carbon-based material during lithium charge and discharge.

### SUMMARY

Aspects of the present invention provide a composite negative active material having improved lifetime cycle characteristics.

Aspects of the present invention provide a method of preparing a composite negative active material having improved lifetime cycle characteristics.

Aspects of the present invention provide a lithium secondary battery having improved lifetime cycle characteristics.

According to an aspect of the present invention, a composite negative active material includes: a porous carbon-based material; and metal nanostructures disposed on one or more of a surface and a plurality of inner pores of the porous carbon-based material.

The metal nanostructures may be grown based on metal catalyst particles disposed on the surface and the plurality of inner pores of the porous carbon-based material.

The metal catalyst particles may be selected from the group consisting of gold (Au), copper (Cu), aluminum (Al), silver (Ag), and nickel (Ni).

The metal nanostructures may include one or more elements selected from t groups 13 and 14 of the Periodic Table.

The metal nanostructures may include Si-based metal nanostructures.

The metal nanostructures may include metal nanowires.

The average diameter of the metal nanowires may be in a range of about 20 nm to about 100 nm.

The content of the metal nanostructure may be in a range of about 10 parts by weight to about 200 parts by weight based on 100 parts by weight of the porous carbon-based material.

The metal nanostructures may further include one or more selected from the group consisting of metal nanofilms, metal nanorods, metal nanotubes, and metal nanoribbons.

The plurality of pores of the porous carbon-based material may be connected to form a channel.

The porous carbon-based material may have a 3-dimensional ordered macroporous structure or a structure similar thereto.

The porous carbon-based material may be particles.

The average particle diameter of the porous carbon-based material may be in a range of about 0.5 μm to about 50 μm.

The porous carbon-based material may be amorphous carbon or crystalline carbon.

The diameter of the pore of the porous carbon-based material may be in a range of about 50 nm to about 300 nm.

A BET (Brunauer, Emmett and Teller) specific surface area of the porous carbon-based material may be in the range of about 10 m²/g to about 1000 m²/g.

An integrated strength ratio D/G (I₁₃₆₀/I₁₅₈₀) of a Raman D-line and G-line of the porous carbon-based material may be in the range of about 0.1 to about 2.

According to another aspect of the present invention, a method of preparing a composite negative active material includes: heat treating a composite of a pore-forming material and a carbon precursor to form a composite of the pore-forming material and carbon; etching the pore-forming material to form porous carbon having nanopores; impregnating the porous carbon with a catalyst to form the porous carbon impregnated with the catalyst; and introducing a metal precursor to the porous carbon impregnated with the catalyst to grow metal nanostructures in pores.

The pore-forming material may be silicon oxides.

The carbon precursor may be selected from the group consisting of petroleum-based pitch, coal-based pitch, polyimide, polybenzimidazole, polyacrylonitrile, mesophase pitch, furfuryl alcohol, furan, phenol, cellulose, sucrose, polyvinyl chloride, and a mixture thereof.

The heat treatment when forming the composite of the pore-forming material and carbon may be performed within the temperature range of about 800° C. to about 3000° C. under an inert gas atmosphere.

The forming of the composite of the pore-forming material and carbon may further include a graphitization-promoting catalyst which may be salts including iron (Fe), aluminum (Al), cobalt (Co), or nickel (Ni).

The diameter of the pore in the porous carbon may be in a range of about 50 nm to about 300 nm.

The catalyst may be selected from the group consisting of Au, Ag, Ni, and Cu.

The metal precursor may include SiH₄ or SiCl₄.

The growing of the metal nanostructures may include a heat treating process within the temperature range of about 400° C. to about 500° C.

At least a portion of the metal nanostructures may be nanowires.

According to another aspect of the present invention, a lithium secondary battery includes: a positive electrode including a positive active material; a negative electrode including a negative active material; and an electrolyte disposed between the positive electrode and the negative electrode, wherein the negative active material includes the foregoing composite negative active material.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a scanning electron microscope (SEM) micrograph showing porous carbon according to an exemplary embodiment;

FIG. 2a is an SEM micrograph showing the composite negative active material according to Example 1;

FIG. 2b is an SEM micrograph showing the 10 times magnified image of FIG. 2a;

FIG. 2c is an SEM micrograph showing the composite negative active material according to Example 2;

FIG. 3a is an SEM micrograph showing the composite negative active material according to Comparative Example 1;

FIG. 3b is an SEM micrograph showing the composite negative active material according to Comparative Example 2;

FIG. 4a is a graph illustrating the experimental results of the nitrogen adsorption isotherm for the porous carbon of Preparation Example 1 at −196° C.;

FIG. 4b is a graph illustrating the experimental results of the nitrogen adsorption isotherm for the composite negative active material of Example 1 at −196° C.;

FIG. 4c is a graph illustrating the experimental results of the nitrogen adsorption isotherm for the composite negative active material of Example 2 at −196° C.;

FIG. 5 is a graph illustrating capacity characteristics of the lithium secondary batteries according to Examples 3 and 4 and Comparative Examples 3 and 4; and

FIG. 6 is an exploded perspective view illustrating the lithium secondary battery according to an exemplary embodiment.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a composite negative active material according to an exemplary embodiment, a method of preparing the same, and a lithium secondary battery including the same will be described in more detail. However, the embodiments of the present invention are merely presented as examples, and the present invention is not limited thereto, but is only defined by the scopes of the following claims.

As an aspect of the present invention, provided is the composite negative active material including a porous carbon-based material and metal nanostructures disposed on one or more of a surface and a plurality of inner pores of the porous carbon-based material.

With respect to a non-carbon-based material such as silicon (Si) having high capacity, lifetime cycle characteristics as well as mechanical properties may degrade due to changes from volume expansion and contraction thereof during lithium charge and discharge.

However, since the composite negative active material includes the porous carbon-based material and the metal nanostructures disposed on one or more of the surface and the plurality of inner pores of the porous carbon-based material, structural stability may be obtained by absorbing volume changes of the metal nanostructures through empty spaces in the porous carbon.

In the specification, the term “disposed” denotes a state in which metal nanostructures are embedded in a portion of the surface and the plurality of inner pores of the porous carbon-based material and/or the metal nanostructures are grown from the embedded surface and surfaces of the plurality inner pores.

In the specification, the term “metal nanostructures” denotes one-, two-, and three-dimensional nanoscale metal nanostructures having the size of about 500 nm or less.

The metal nanostructures may be grown based on metal catalyst particles disposed on the surface and the plurality of inner pores of the porous carbon-based material. A known vapor-liquid-solid (VLS) growth method may be used as the method of growing the metal nanostructures. The VLS growth method denotes a one-dimensional growing technique through adsorption of a reaction material on a catalyst material formed of nano-clusters or nanoscale droplets.

The metal catalyst particles may be selected from the group consisting of gold (Au), copper (Cu), aluminum (Al), silver (Ag), and nickel (Ni). For example, the metal catalyst particles may be Au.

The metal nanostructures may include one or more elements selected from the group consisting of groups 13 and 14 of the Periodic Table. For example, the metal nanostructures may include one or more elements from group 14 of the Periodic Table.

The metal nanostructures, for example, may include Si-based metal nanostructures. Since the metal nanostructures have a density capacity higher than that of graphite, the composite negative active material including the metal nanostructures may exhibit high capacity.

The metal nanostructures may include metal nanowires.

In the specification, the term “metal nanowire” is used as a concept including a form of a metal wire having a diameter in a nanometer scale range and a high aspect ratio. Herein, the aspect ratio denotes a ratio of length to width (length:width).

An average diameter of the metal nanowires may be in the range of about 20 nm to about 100 nm, and for example, may be in the range of about 30 nm to about 50 nm. The metal nanowires having an average diameter within the foregoing range maintain a specific surface area within an appropriate range such that the composite negative active material has improved energy density and lifetime characteristics. A length of the metal nanowire may be in the range of about 1 μm to about 100 μm, for example, may be in the range of about 5 μm to about 50 μm, and for example, may be in the range of about 10 μm to about 30 μm.

A content of the metal nanostructure may be in the range of about 10 parts by weight to about 200 parts by weight based on 100 parts by weight of the porous carbon-based material, for example, may be in the range of about 10 parts by weight to about 150 parts by weight, and for example, may be in the range of about 10 parts by weight to about 70 parts by weight. When the content of the metal nanostructure is within the foregoing range, volume changes in the metal nanostructures, as a function of lithium charge and discharge, may be effectively buffered.

The metal nanostructures may further include one or more selected from the group consisting of metal nanofilms, metal nanorods, metal nanotubes, and metal nanoribbons.

In the specification, the term “metal nanofilm” denotes a metal film having a diameter or thickness of about 500 nm or less, the term “metal nanorod” is similar to the metal nanowire defined in the specification but denotes a metal rod having an aspect ratio smaller than that of the metal nanowire, the term “metal nanotube” denotes a metal tube having a diameter of about 500 nm, and the term “metal nanoribbon” denotes a metal ribbon having a width of about 100 nm and an aspect ratio of about 10 or more. For example, the metal nanostructures may further include Si nanofilms or Si nanorods. For example, the metal nanofilms may be embedded in one or more of the surface and the plurality of inner pores of the porous carbon-based material, and the metal nanorods may be grown from the embedded surface and the surfaces of the plurality of inner pores of the porous carbon-based material.

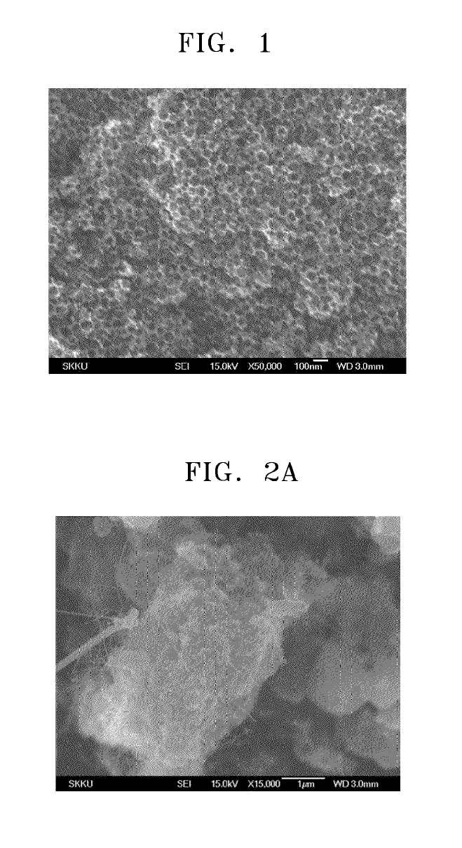

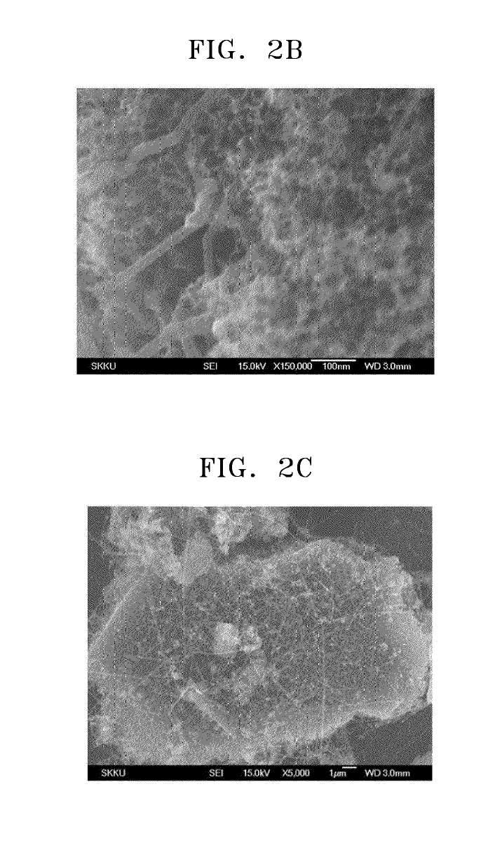

The plurality of pores of the porous carbon-based material is connected to be able to form a channel. The metal nanostructures may be disposed in the channels of the porous carbon-based material. For example, as shown in FIGS. 2a and 2b, the metal nanostructures may be embedded in the channels formed through the connection of the plurality of pores of the porous carbon-based material, or the metal nanostructures may be grown from the surfaces of the channels of the embedded pores.

When the metal nanostructures are disposed in the channels of the porous carbon-based material, sufficient volume may be used without damaging the structure of the porous carbon-based material, and good contacts between the metal nanostructures and the porous carbon-based material may be obtained such that electron and ion conduction properties may be improved. As a result, high-rate and lifetime characteristics may be improved.

The porous carbon-based material may have a 3-dimensional ordered macroporous structure or a structure similar thereto. The term “a structure similar thereto” may include a honeycomb-type structure having uniform pores or the like.

The porous carbon-based material may be particles. An average particle diameter of the porous carbon-based material may be in the range of about 0.5 μm to about 50 μm, for example, may be in the range of about 1 μm to about 30 μm, and for example, may be in the range of about 5 μm to about 20 μm.

The porous carbon-based material may be amorphous carbon or crystalline carbon. Exemplary embodiments of the amorphous carbon may be soft carbon (low-temperature fired carbon) or hard carbon, mesophase pitch carbide, fired coke, etc. Exemplary embodiments of the crystalline carbon may be graphite such as shapeless, plate, flake, spherical, or fibrous natural graphite or artificial graphite. The porous carbon, for example, may be graphite, carbon particles, carbon nanotubes, or graphenes, but the porous carbon is not limited thereto.

A diameter of the pore of the porous carbon-based material may be in the range of about 50 nm to about 300 nm, for example, may be in the range of about 50 nm to about 250 nm, and for example, may be in the range of about 50 nm to about 200 nm. The porous carbon having a pore diameter within the foregoing range may not only have favorable high-rate characteristics of the lithium secondary battery because specific surface area generating a side reaction with an electrolyte is lessened, but lifetime characteristics may also be improved by minimizing the stress of the volume changes in the metal nanostructures.

A BET (Brunauer, Emmett and Teller) specific surface area of the porous carbon-based material may be in the range of about 10 m²/g to about 1000 m²/g, for example, may be in the range of about 10 m²/g to about 100 m²/g, and for example, may be in the range of about 10 m²/g to about 50 m²/g. When the BET specific surface area and the volume of the pores of the porous carbon-based material are within the foregoing ranges, the porous carbon-based material may have sufficient mechanical strength during lithium charge and discharge, and high-rate and lifetime characteristics of the lithium secondary battery may be improved.

An integrated strength ratio D/G (I₁₃₆₀/I₁₅₈₀) of a Raman D-line and G-line of the porous carbon-based material may be in the range of about 0.1 to about 2, for example, may be in the range of about 0.1 to about 1.9, and for example, may be in the range of about 0.2 to about 1.7. The porous carbon-based material having the integrated strength ratio D/G (I₁₃₆₀/I₁₅₈₀) of a Raman D-line and G-line within the foregoing range may have desired electrical conductivity.

As another aspect of the invention, a method of preparing a composite negative active material includes: heat treating a mixture of a pore-forming material and a carbon precursor to form a composite of the pore-forming material and carbon; etching the pore-forming material to form porous carbon having nanopores; impregnating the porous carbon with a catalyst to form the porous carbon impregnated with the catalyst; and introducing a metal precursor to the porous carbon impregnated with the catalyst to grow metal nanostructures in pores.

In the method of preparing a composite negative active material, the mixture is formed by mixing the pore-forming material and the carbon precursor.

The pore-forming material may be a silicon oxide, and for example, may be SiO₂. The pore-forming material may form nanopores having a predetermined size and for example, may be powder or particles having the size range of about 30 nm to about 200 nm.

The carbon precursor may be selected from the group consisting of petroleum-based pitch, coal-based pitch, polyimide, polybenzimidazole, polyacrylonitrile, mesophase pitch, furfuryl alcohol, furan, phenol, cellulose, sucrose, polyvinyl chloride, and a mixture thereof. For example, the carbon precursor may be petroleum-based pitch, coal-based pitch, polyimide, polybenzimidazole, polyacrylonitrile, mesophase pitch, or sucrose, but the carbon precursor is not limited thereto and any carbon precursor that is used in the art may be used.

A composite of the pore-forming material and carbon is formed by heat treating the mixture. The heat treatment may be performed within the temperature range of about 800° C. to about 3000° C. under an inert gas atmosphere, and for example, may be performed within the temperature range of about 800° C. to about 2000° C. The composite of the pore-forming material and carbon is formed by carbonizing the mixture for about 0.5 hours to about 10 hours, for example, about 1 hour to about 5 hours. A side reaction may be prevented in the foregoing case.

The forming of the composite of the pore-forming material and carbon may further include a graphitization-promoting catalyst which may include salts such as iron (Fe), aluminium (Al), cobalt (Co), or nickel (Ni). For example, oxides, nitrides, or chlorides of Fe, Al, Co, or Ni may be used.

Porous carbon having nanopores is formed by etching the pore-forming material. A diameter of the pore in the porous carbon may be in the range of about 50 nm to about 300 nm, for example, may be in the range of about 50 nm to about 250 nm, and for example, may be in the range of about 50 nm to about 200 nm. The porous carbon having a pore diameter within the foregoing range has a low specific surface area that generates a side reaction with an electrolyte such that high-rate and lifetime characteristics may be improved.

The porous carbon is impregnated with the catalyst to form the porous carbon impregnated with the catalyst. The catalyst may be selected from the group consisting of Au, Ag, Ni, and Cu, For example, the catalyst may be Au. The porous carbon impregnated with the catalyst is formed by impregnating the porous carbon in a solution containing the catalyst and drying.

A metal precursor is introduced into the porous carbon impregnated with the catalyst to grow metal nanostructures in pores. The metal precursor may include SiH₄ or SiCl₄, but the metal precursor is not limited thereto and any metal precursor that is used as a chemical vapour deposition (CVD) metal precursor may be used.

The growing of the metal nanostructures may include a process of heat treating within the temperature range of about 400° C. to about 500° C., for example, may include a process of heat treating within the temperature range of about 420° C. to about 490° C., and for example, may include a process of heat treating within the temperature range of about 420° C. to about 470° C. For example, the process of heat treating may be performed for about 1 minute to about 10 hours, and for example, may be performed for about 1 minute to about 3 hours.

When the metal nanostructures are grown within the foregoing temperature ranges, a composite negative active material may be obtained, in which the metal nanostructures are disposed on one or more of the surface and the plurality of inner pores of the porous carbon, or particularly, are embedded in channels formed through the connection of the plurality of pores of the porous carbon, and/or are grown from surfaces of the channels of the embedded pores of the porous carbon.

At least a portion of the metal nanostructures may be nanowires. An average diameter of the nanowires may be in the range of about 20 nm to about 100 nm, for example, may be in the range of about 20 nm to about 35 nm, and for example, may be in the range of about 20 nm to about 30 nm.

A length of the nanowire may be in the range of about 1 μm to about 100 μm, for example, may be the range of about 5 μm to about 50 μm, and for example, may be in the range of about 10 μm to about 30 μm.

As another aspect of the present invention, a lithium secondary battery includes: a positive electrode including a positive active material; a negative electrode including a negative active material; and an electrolyte disposed between the positive electrode and the negative electrode, wherein the negative active material includes the foregoing composite negative active material.

Since the lithium secondary battery includes metal nanostructures disposed on one or more of the surface and the plurality of inner pores of the porous carbon-based material, contacts between the metal nanostructures and the porous carbon-based material are good during lithium charge and discharge such that high-rate characteristics thereof may be improved, and lifetime characteristics may be improved because structural stability is improved by minimizing the stress of the volume changes in the metal nanostructures.

FIG. 6 is an exploded perspective view illustrating a lithium secondary battery according to an exemplary embodiment. In FIG. 6, a schematic drawing of a configuration of a cylindrical battery is shown, but the battery of the invention is not limited thereto and a prismatic or pouch type battery may be formed.

A lithium secondary battery may be classified as a lithium-ion battery, a lithium-ion polymer battery, or a lithium polymer battery according to the types of separators and electrolytes used. A lithium secondary battery may also be classified as a cylindrical type, a prismatic type, a coin type, or a pouch type battery according to its shape, and classified as a bulk type or a thin-film type according to its size. The shape of the lithium secondary battery, according to the exemplary embodiment, is not particularly limited, and structures and preparation methods of the foregoing batteries are known in the art and thus, detailed descriptions thereof are omitted.

When the lithium secondary battery is described in more detail with reference to FIG. 6, the lithium secondary battery 100 is a cylindrical type battery and is composed of a negative electrode 112, positive electrode 114, separator 113 disposed between the negative electrode 112 and the positive electrode 114, an electrolyte (not shown) impregnating the negative electrode 112, the positive electrode 114, and the separator 113, battery case 120, and sealing member 140 for sealing the battery case 120. The negative electrode 112, the positive electrode 114 and the separator 113 are sequentially stacked, and then wound in a spiral shape. The lithium secondary battery 100 is then formed by containing the spiral-shaped wound stack in the battery case 120.

The negative electrode 112 includes a current collector and a negative active material layer formed on the current collector. The negative active material layer includes a negative active material.

For the current collector used in the negative electrode 112, a copper, nickel, or stainless steel (SUS) current collector may be used according to the voltage range. For example, a copper current collector may be used.

The negative active material includes the foregoing composite negative active material. Since contacts between Si nanostructures and porous carbon of the lithium secondary battery, including the foregoing composite negative active material, are good during charge and discharge, high-rate characteristics of the lithium secondary battery may be improved and lifetime characteristics thereof may be improved. This is due to improved structural stability by minimizing the stress of the volume changes in the Si nanostructures during lithium charge and discharge.

The negative active material layer also includes a binder and may selectively further include a conductive agent. The binder acts to bond negative active material particles to one another and also acts to bond the negative active material to the current collector. Exemplary embodiment of the binder may be polyvinyl alcohol, carboxymethyl cellulose, hydroxypropyl cellulose, diacetyl cellulose, polyvinyl chloride, carboxylic polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, etc. However, the binder is not limited thereto.

The conductive agent is used to provide conductivity to an electrode and any conductive agent may be used so long as it does not cause chemical changes in the constituted battery and is an electron conductive material. Exemplary embodiments of the conductive agent may be natural graphite, artificial graphite, carbon black, acetylene black, carbon fibers, metal powders such as copper, nickel, aluminium, silver, or metal fibers. Also, the conductive agent may be used by mixing conductive materials such as a polyphenylene derivative. Exemplary embodiment of the current collector may be a copper foil, a nickel foil, a stainless steel foil, a titanium foil, a nickel foam, a copper foam, a conductive metal coated polymer base, or combinations thereof.

In the exemplary embodiment, contents of the negative active material, binder, and conductive agent are at amounts generally used in the lithium secondary battery. For example, a weight ratio of the negative active material to a mixture of the conductive agent and the binder is in the range of about 98:2 to about 92:8, and a mixing ratio between the conductive agent and the binder may be in the range of about 1:1.5 to about 1:3. However, the ratios are not limited thereto.

The positive electrode 114 includes a current collector and a positive active material layer formed on the current collector. Al may be used as a current collector, but the current collector is not limited thereto. The positive active material is not particularly limited so long as it is generally used in the art, but more particularly, a compound capable of having reversible intercalation and deintercalation of lithium ions may be used. For example, one or more composite oxides of metals selected may include cobalt, manganese, nickel, or combinations thereof. Lithium may also be used. As exemplary examples thereof, a compound expressed as one of the following chemical formulas may be used: LiₐA_{1-b}L1_{b}D₂ (where 0.90≦a≦1.8, 0≦b≦0.5); LiₐE_{1-b}L1_{b}O_{2-c}D_{c} (where 0.90≦a≦1.8, 0≦b≦0.5, 0≦c≦0.05); LiE_{2-b}L1_{b}O_{4-c}D_{c} (where 0≦b≦0.5, 0≦c≦0.05); LiₐNi_{1-b-c}Co_{b}L1_{c}D_{α} (where 0.90≦a≦1.8, 0≦b≦0.5, 0≦c≦0.05, 0<a≦2); LiₐNi_{1-b-c}Co_{b}L1_{c}O_{2-α}T1_{α} (where 0.90≦a≦1.8, 0≦b≦0.5, 0≦c≦0.05, 0<α<2); LiₐNi_{1-b-c}Co_{b}L1_{c}O₂₋₆₀ T1_{α} (where 0.90≦a≦1.8, 0≦b≦0.5, 0≦c≦0.05, 0<α<2); LiₐNi_{1-b-c}Mn_{b}L1_{c}D_{α} (where 0.90≦a≦1.8, 0≦b≦0.5, 0≦c≦0.05, 0<α<2); LiₐNi_{1-b-c}Mn_{b}L1_{c}O_{2-α}T1₂ (where 0.90≦a≦1.8, 0≦b≦0.5, 0≦c≦0.05, 0<α<2); LiₐNi_{1-b-c}Mn_{b}L1_{c}O_{2-α}T1_{α} (where 0.90≦a≦1.8, 0≦b≦0.5, 0≦c≦0.05, 0<α<2); LiₐNi_{b}E_{c}G_{d}O₂ (where 0.90≦a≦1.8, 0≦b≦0.9, 0≦c≦0.5, 0.001≦d≦0.1); LiₐNi_{b}Co_{c}Mn_{d}GeO₂ (where 0.90≦a≦1.8, 0≦b≦0.9, 0≦c≦0.5, 0≦d≦0.5, 0.001≦e≦0.1); LiₐNiG_{b}O₂ (where 0.90≦a≦1.8, 0.001≦b≦0.1); LiₐCoG_{b}O₂ (where 0.90≦a≦1.8, 0.001≦b≦0.1); LiₐMnG_{b}O₂ (where 0.90≦a≦1.8, 0.001≦b≦0.1); LiₐMnG_{b}O₄ (where 0.90≦a≦1.8, 0.001≦b≦0.1); QO₂; QS₂; LiQS₂; V₂O₅; LiV₂O₅; LiY1O₂; LiNiVO₄; Li_{(3-f)}J₂(PO₄)₃ (0≦f≦2); Li_{(3-f)}Fe₂(PO₄)₃ (0≦f≦2); and LiFePO₄.

Exemplary examples of the positive active material may be LiMn₂O₄, LiNi₂O₄, LiCoO₂, LiNiO₂, LiMnO₂, Li₂MnO₃, LiFePO₄, LiNiₓCo_{y}O₂ (0<x≦0.15, 0<y≦0.85), etc. Exemplary examples of the positive active material may be Li₁₊ₓ(M)₁₋ₓO₂ (0.05≦x≦0.2) and M may be a transition metal. Examples of the transition metal M may be Ni, Co, Mn, Fe, or Ti, but the transition metal M is not limited thereto. Since the positive active material has a larger ratio of the lithium ion than that of the transition metal M, the capacity of the lithium secondary battery, including the positive electrode and the positive active material, may be further improved.

In the above chemical formulas, A is Ni, Co, Mn, or a combination thereof; L1 is Al, Ni, Co, Mn, Cr, Fe, Mg, Sr, V, rare earth elements, or a combination thereof; D is O, T1, S, P, or a combination thereof; E is Co, Mn, or a combination thereof; T1 is F, S, P, or a combination thereof; G is Al, Cr, Mn, Fe, Mg, La, Ce, Sr, V, or a combination thereof; Q is Ti, Mo, Mn, or a combination thereof; Y1 is Cr, V, Fe, Sc, Y, or a combination thereof; J is V, Cr, Mn, Co, Ni, Cu, or a combination thereof.

A compound having a coating layer on the foregoing compounds may be used, or a compound may be used by mixing the foregoing compounds and the compound having a coating layer. The coating layer may include a compound of a coating element such as oxide, hydroxide, oxyhydroxide, oxycarbonate, or hydroxycarbonate. The compound constituting the coating layer may be amorphous or crystalline. Exemplary embodiments of the coating element included in the coating layer may be Mg, Al, Co, K, Na, Ca, Si, Ti, V, Sn, Ge, Ga, B, As, Zr, or combinations thereof. Any coating method may be used for the process of forming the coating layer as long as coating may be performed by a method (e.g., spray coating, dipping, etc.) that does not adversely affect the physical properties of the positive active material due to using such coating elements on the foregoing compounds. Detailed descriptions of the coating method are not provided because it is obvious to those skilled in the art.

The positive active material layer may also include a binder and a conductive agent. The binder acts to bond positive active material particles to one another and also acts to bond the positive active material to a current collector. Exemplary embodiments of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, polyamide, etc. However, the binder is not limited thereto.

The conductive agent is used to provide conductivity to the electrode. Any conductive agent may be used so long as it does not cause chemical changes in the battery and is an electron conductive material. Exemplary embodiments of the conductive agent may be natural graphite, artificial graphite, carbon black, acetylene black, carbon fibers, metal powders such as copper, nickel, aluminium, silver, or metal fibers. Also, the conductive agent may be used by mixing one or more conductive materials such as a polyphenylene derivative.

The contents of the cathode active material, binder, and conductive agent are at amounts generally used in the lithium secondary battery. For example, the weight ratio of the positive active material to the mixture of the conductive agent and the binder is in the range of about 98:2 to about 92:8, and the mixing weight ratio between the conductive agent and the binder may be in the range of about 1:1.5 to about 1:3. However, the ratios are not limited thereto.

Active material compositions are prepared by mixing active materials, binders, and conductive agents in a solvent, and the negative electrode 112 and the positive electrode 114 are then prepared by coating the current collectors with the active material compositions, respectively. Since the foregoing methods of preparing an electrode are widely known in the art, detailed descriptions thereof are omitted in the specification. N-methylpyrrolidone or the like may be used as the solvent, but the solvent is not limited thereto.

A separator may exist between the positive electrode and the negative electrode according to the type of a lithium secondary battery. Polyethylene, polypropylene, polyvinylidene fluoride, or a multilayer having two or more layers thereof may be used as the separator, and a mixed multilayer, such as a polyethylene/polypropylene double-layered separator, a polyethylene/polypropylene/polyethylene triple-layered separator, or a polypropylene/polyethylene/polypropylene triple-layered separator, may be used as the separator.

The electrolyte (not shown) impregnating the negative electrode 112, the positive electrode 114, and the separator 113 may include a non-aqueous-based organic solvent and a lithium salt. The non-aqueous-based organic solvent may act as a medium in which ions participating in an electrochemical reaction of a battery may move.

A carbonate-based, ester-based, ether-based, ketone-based, alcohol-based, or aprotic solvent may be used as the non-aqueous-based organic solvent. Dimethyl carbonate (DMC), diethyl carbonate (DEC), di-n-propyl carbonate (DPC), methyl n-propyl carbonate, ethyl n-propyl carbonate, ethylmethyl carbonate (EMC), ethylene carbonate (EC), propylene carbonate (PC), or butylene carbonate (BC) may be used as the carbonate-based solvent. Methyl acetate, ethyl acetate, n-propyl acetate, tert-butyl acetate, methyl n-propionate, ethyl n-propionate, γ-butyrolactone, 5-decanolide, γ-valerolactone, dl-mevalonolactone, or ε-caprolactone may be used as the ester-based solvent. Dibutyl ether, tetraglyme, diglyme, dimethoxyethane, 2-methyltetrahydrofuran, or tetrahydrofuran may be used as the ether-based solvent, and cyclohexanone may be used as the ketone-based solvent. Also, ethyl alcohol or isopropyl alcohol may be used as the alcohol-based solvent, and nitriles such as R—CN (where R is a hydrocarbon group with a carbon number of about 2 to about 20 having a linear, branched, or cyclic structure and may include a double-bonded aromatic ring or an ether bond), amides such as dimethylformamide, dioxolanes such as 1,3-dioxolane, or sulfolanes may be used as the aprotic solvent.

The non-aqueous-based organic solvent may be used alone or by mixing one or more non-aqueous-based organic solvents. When the non-aqueous-based organic solvent is used by mixing one or more non-aqueous-based organic solvents, a mixing weight ratio may be appropriately adjusted according to the desired battery performance and this may be widely understood by those skilled in the art.

The lithium salt is dissolved in an organic solvent. This enables basic operation of the lithium battery by acting as a source of lithium ions in the battery, and is a material for promoting transfer of lithium ions between the positive electrode and the negative electrode. For example, the lithium salt may include one or more selected from the group consisting of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂) (C_{y}F_{2y+1}SO₂) (where x and y are natural numbers), LiCl, Lil, and LiB(C₂O₄)₂ (lithium bis(oxalato) borate (LiBOB)) as a supporting electrolyte salt. A concentration of the lithium salt may be in the range of about 0.1 M to about 2.0 M. When the concentration of the lithium salt is included within this range, an electrolyte may have appropriate conductivity and viscosity. Therefore, excellent electrolyte performance may be obtained and lithium ions may be effectively transferred.

Hereinafter, particular examples of the present invention are described. However, the following examples are merely presented to particularly exemplify and describe the present invention, and the present invention is not limited thereto.

Also, since those skilled in the art may sufficiently and technically infer contents not described herein, the descriptions thereof are omitted.

### EXAMPLES

### Preparation of Porous Carbon

### Preparation Example 1

SiO₂ nanopowder having an average diameter of about 80 nm and petroleum-based pitch (AR mesophase pitch, Mitsubishi Gas Chemical Co., Ltd.) were mixed in a weight ratio of about 50:50. The mixture was heat treated at about 1000° C. in a nitrogen gas atmosphere and carbonized to form a composite of SiO₂ and carbon. The composite was etched by dipping in a 5M NaOH solution for about 24 hours to prepare porous carbon having an average pore diameter of about 80 nm. An integrated strength ratio D/G (I₁₃₆₀/I₁₅₈₀) of a Raman D-line and G-line of the porous carbon was about 1.8 and an SEM micrograph of the prepared porous carbon is shown in FIG. 1.

### Comparative Preparation Example 1

Graphite (MCMB2528: Osaka Gas Co., Ltd.) was obtained and prepared as it is.

### Comparative Preparation Example 2

Amorphous carbon (Super-P: TIMCAL Graphite & Carbon) was obtained and prepared as it is.

### Preparation of Composite Negative Active Materials

### Example 1

About 2 g of the porous carbon prepared in Preparation Example 1 was impregnated in about 200 cc of a 0.001 M HAuCl₄ (Sigma-Aldrich Corporation) ethanol solution and stirred for about 24 hours. Porous carbon powder impregnated with Au was then prepared by slowly drying ethanol at about 80° C. and heat treating at about 500° C. for about 6 hours. The porous carbon powder was put into a small tube having holes in front and rear sides thereof, and the holes in both sides were blocked with quartz wool so as to prevent the powder from being blown away during pumping in a CVD chamber. About 10 sccm of silane gas (SiH₄, about 10% diluted H₂ gas) was injected into the CVD chamber to make a total pressure of about 8 Torr. The small tube put in the center of the CVD chamber was heated at about 490° C. for about 5 minutes. The temperature was decreased to about 440° C. for about 10 minutes and then maintained for about 2 hours to obtain a composite negative active material in which Si nanowires were grown in pores included in the porous carbon. The weight of the composite negative active material was about 0.18 g and the results of SEM microscopy of the composite negative active material may be confirmed by the FIGS. 2a and 2b.

### Example 2

A composite negative active material was obtained in the same manner as Example 1 except that the temperature was decreased to about 460° C. for about 10 minutes and then maintained for about 2 hours instead of decreasing the temperature to about 440° C. for about 10 minutes and then maintaining it for about 2 hours. The weight of the composite negative active material was about 0.19 g and the results of SEM microscopy of the composite negative active material may be confirmed by FIG. 2c.

### Comparative Example 1

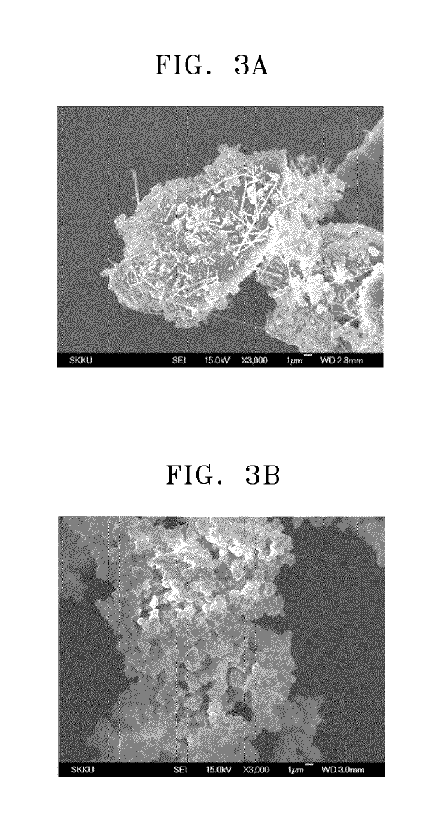

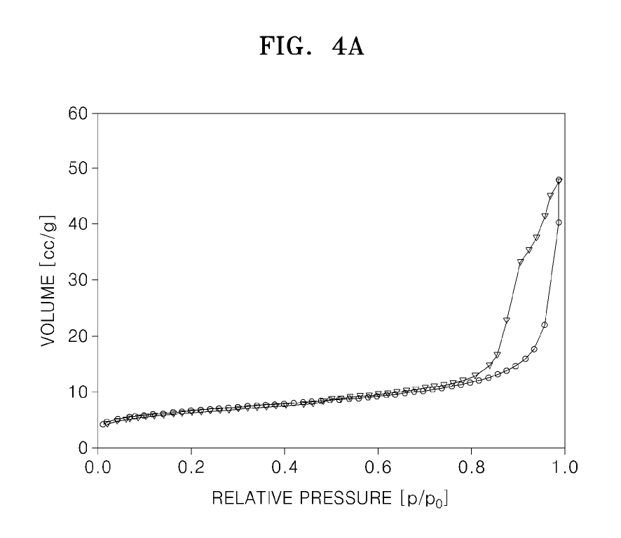

A composite negative active material was obtained in the same manner as Example 1 except that the graphite of Comparative Preparation Example 1 was used instead of using the porous carbon powder impregnated with Au. The results of SEM microscopy of the composite negative active material may be confirmed by FIG. 3a.

### Comparative Example 2

A composite negative active material was obtained in the same manner as Example 1 except that the amorphous carbon of Comparative Preparation Example 2 was used instead of using the porous carbon powder impregnated with Au. The results of SEM microscopy of the composite negative active material may be confirmed by FIG. 3b.

### Preparation of Lithium Secondary Batteries

### Example 3

The composite negative active material of Example 1, graphite, and a polyamide-imide binder were mixed in a weight ratio of about 3:6:1 in an N-methylpyrrolidone solvent to prepare a negative active material slurry. The negative active material slurry was coated on about 15 μm of thick copper foil and dried at about 200° C. for about 60 minutes, and a negative electrode was then prepared by roll-pressing. A coin-type half-cell was prepared in a helium-filled glove box by using the negative electrode, a lithium counter electrode, a microporous polypropylene separator (Celgard 3501), and an electrolyte having a volume ratio of ethylene carbonate:diethylene carbonate:fluoroethylene carbonate (EC:DEC:FEC) of about 2:6:2.

### Example 4

A coin-type half-cell was prepared in the same manner as Example 3 except that the composite negative active material of Example 2 was used instead of using the composite negative active material of Example 1.

### Comparative Example 3

A coin-type half-cell was prepared in the same manner as Example 3 except that the composite negative active material of Comparative Example 1 was used instead of using the composite negative active material of Example 1.

### Comparative Example 4

A coin-type half-cell was prepared in the same manner as Example 3 except that the composite negative active material of Comparative Example 2 was used instead of using the composite negative active material of Example 1.

### Performance Evaluations of Composite Negative Active Materials and Lithium Secondary Batteries

### Evaluation Example 1

### Scanning Electron Microscope (SEM) Micrographs

The composite negative active materials of Examples 1 and 2 and Comparative Examples 1 and 2 were photographed by using an SEM. The results thereof are presented in FIGS. 2a to 2c, 3a, and 3b, respectively.

Referring to FIGS. 2a and 2b, composite particles were formed in the composite negative active material of Example 1, in which most of Si nanowires or Si nanofilms were disposed in pores and channels connecting the plurality of pores inside porous carbon, and thus, the Si nanowires were embedded, and Si nanowires were also grown in the pores and the channels embedded in the porous carbon.

Referring to FIG. 2c, composite particles were formed in the composite negative active material of Example 2, in which most of Si nanowires or Si nanofilms were embedded in surface pores of porous carbon and Si nanowires were also grown from surfaces of the pores embedded in the porous carbon.

Referring to FIG. 3a, Si nanofilms were grown on a surface of graphite and Si nanowires were grown thereon in the composite negative active material of Comparative Example 1.

Referring to FIG. 3b, Si nanofilms were only grown on a surface of amorphous carbon and Si nanowires were not grown thereon in the composite negative active material of Comparative Example 2.

### Evaluation Example 2

### Nitrogen Adsorption Isotherm Analysis

Nitrogen adsorption isotherms of the porous carbon of Preparation Example 1 and the composite negative active materials of Examples 1 and 2, which were vacuum degassed at about 200° C. for about 300 minutes, were measured by using a TriStar gas adsorption analyzer of Micromeritics Instrument Corporation, and BET specific surface area was calculated within the relative nitrogen pressure (P/P₀) range of about 0 to about 1.0 by using the BET method.

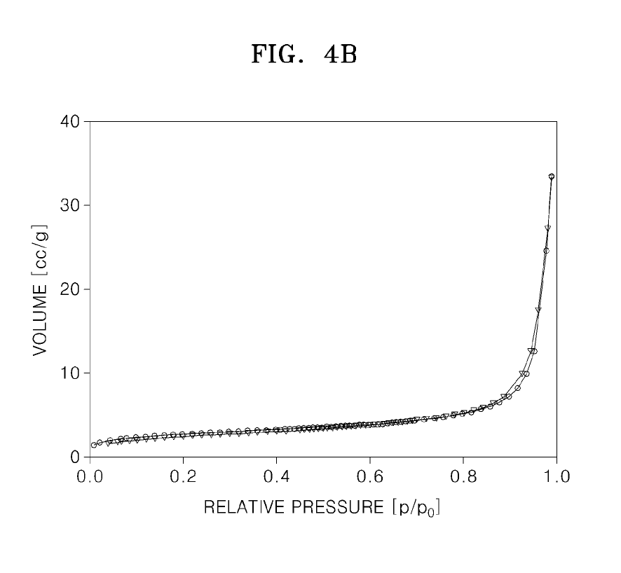

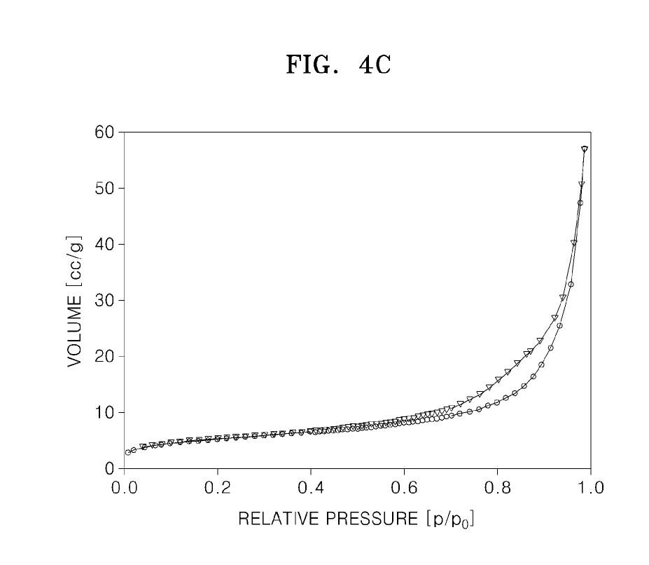

The results thereof are shown in Table 1, and FIGS. 4a to 4c.

FIGS. 4a to 4c illustrate amounts (cc) of nitrogen adsorbed for 1 g of porous carbon samples under ambient conditions according to relative nitrogen pressure (P/P₀) and normalized by the specific gravity of liquid nitrogen at a corresponding temperature, in which a lower line represents an adsorption curve of nitrogen gas and an upper line represents a desorption curve of nitrogen gas.

TABLE 1

| | BET specific surface area of |
|---|---|
| Category | porous carbon (m²/g ) |
| Preparation Example 1 | 24 |
| Example 1 | 10 |
| Example 2 | 19 |

Referring to Table 1 and FIG. 4a, the BET specific surface area of the porous carbon of Preparation Example 1 was about 24 m²/g. Also, referring to Table 1 and FIGS. 4b and 4c, the BET specific surface areas of the composite negative active materials of Examples 1 and 2 were about 10 m²/g and about 19 m²/g, respectively.

### Evaluation Example 3

### Capacity Characteristics of Lithium Secondary Batteries

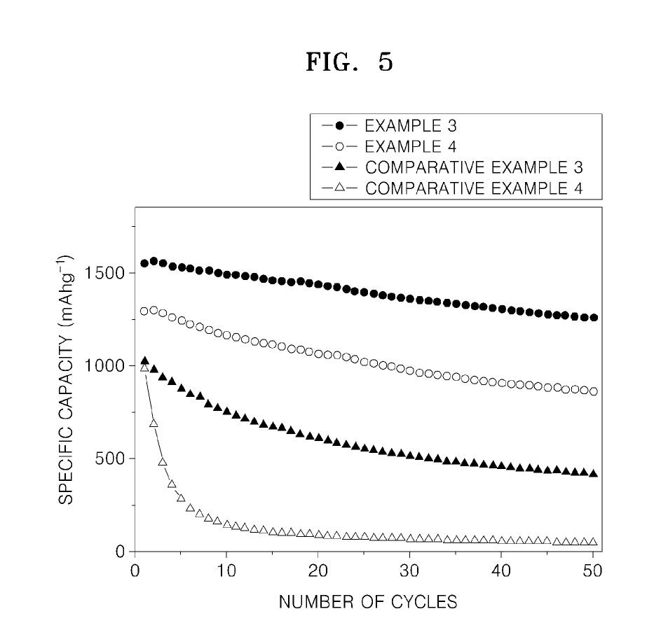

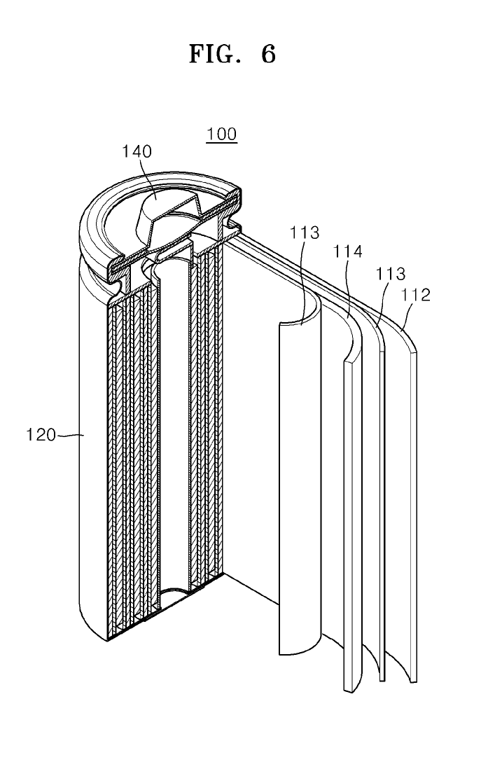

Lifetime cycle characteristics were evaluated by performing about 50 cycles of charge and discharge at 0.1 C in the voltage range of about 0.001 V to about 1.5 V on the coin-type half-cells of Examples 3 and 4 and Comparative Examples 3 and 4, and the results thereof are presented in Table 2 and FIG. 5.

Discharge capacity in each cycle and discharge capacity in a 50th cycle were measured for each battery and cycle capacity retention ratios were calculated therefrom. The capacity retention ratio (%) is expressed as Equation 1 below.

Capacity retention ratio(%)=discharge capacity in the 50th cycle/discharge capacity in the 1st cycle [Equation 1]

TABLE 2

| | Discharge | Discharge | Capacity |
|---|---|---|---|
| | capacity in the | capacity in a | retention |
| Category | 1st cycle (mAh/g) | 50th cycle (mAh/g) | ratio (%) |
| Example 3 | 1550 | 1262 | 81.4 |
| Example 4 | 1295 | 866 | 66.9 |
| Comparative | 1025 | 420 | 41.0 |
| Example 3 | | | |
| Comparative | 985 | 50 | 5.1 |
| Example 4 | | | |

Referring to Table 2 and FIG. 5, the capacitance retention ratios of the lithium secondary batteries prepared in Examples 3 and 4 were more improved than those of Comparative Examples 3 and 4.

Therefore, it may be understood that structural stabilities during charge and discharge of the lithium secondary batteries of Examples 3 and 4 including the composite negative active materials of Examples 1 and 2, i.e., lithium batteries including composite negative active materials, in which Si nanostructures and porous carbon were included, and the Si nanostructures (Si nanowires or Si nanofilms) were disposed on one or more of the surface and the plurality of inner pores of the porous carbon, were improved in comparison to those of the lithium batteries of Comparative Examples 3 and 4, i.e., lithium batteries including composite negative active materials, in which Si nanowires were grown on a surface of graphite and Si nanofilms were formed on amorphous carbon, and thus, lifetime characteristics thereof were improved.

Since structural stability during charge and discharge of the composite negative active material according to an aspect of the present invention is improved by including the porous carbon-based material and metal nanostructures disposed on one or more of the surface and the plurality of inner pores of the porous carbon-based material, lifetime characteristics thereof may be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A composite negative active material comprising:
a porous carbon-based material; and
metal nanostructures disposed on one or more of a surface and a plurality of inner pores of the porous carbon-based material.

2. The composite negative active material of claim 1, wherein the metal nanostructures are grown based on metal catalyst particles disposed on the surface and the inner pores of the porous carbon-based material.

3. The composite negative active material of claim 2, wherein the metal catalyst particles are selected from the group consisting of gold (Au), copper (Cu), aluminum (Al), silver (Ag), and nickel (Ni).

4. The composite negative active material of claim 1, wherein the metal nanostructures are selected from the group consisting of groups 13 and 14 of the Periodic Table.

5. The composite negative active material of claim 1, wherein the metal nanostructures comprise Si-based metal nanostructures.

6. The composite negative active material of claim 1, wherein the metal nanostructures comprise metal nanowires.

7. The composite negative active material of claim 6, wherein the average diameter of the metal nanowires is in a range of about 20 nm to about 100 nm.

8. The composite negative active material of claim 1, wherein the content of the metal nanostructure is in a range of about 10 parts by weight to about 200 parts by weight based on 100 parts by weight of the porous carbon-based material.

9. The composite negative active material of claim 1, wherein the content of the metal nanostructure is in a range of about 10 parts by weight to about 150 parts by weight based on 100 parts by weight of the porous carbon-based material.

10. The composite negative active material of claim 1, wherein the content of the metal nanostructure is in a range of about 10 parts by weight to about 70 parts by weight based on 100 parts by weight of the porous carbon-based material.

11. The composite negative active material of claim 1, wherein the metal nanostructures are selected from the group consisting of metal nanofilms, metal nanorods, metal nanotubes, and metal nanoribbons.

12. The composite negative active material of claim 1, wherein the plurality of pores of the porous carbon-based material is connected to form a channel.

13. The composite negative active material of claim 1, wherein the porous carbon-based material has a 3-dimensional ordered macroporous structure or a structure similar thereto.

14. The composite negative active material of claim 1, wherein the porous carbon-based material is particles.

15. The composite negative active material of claim 1, wherein the average particle diameter of the porous carbon-based material is in a range of about 0.5 μm to about 50 μm.

16. The composite negative active material of claim 1, wherein the porous carbon-based material is amorphous carbon or crystalline carbon.

17. The composite negative active material of claim 1, wherein the diameter of the pore of the porous carbon-based material is in a range of about 50 nm to about 300 nm.

18. The composite negative active material of claim 1, wherein the BET (Brunauer, Emmett and Teller) specific surface area of the porous carbon-based material is in a range of about 10 m²/g to about 1000 m²/g.

19. The composite negative active material of claim 1, wherein the BET (Brunauer, Emmett and Teller) specific surface area of the porous carbon-based material is in a range of about 10 m²/g to about 100 m²/g.

20. The composite negative active material of claim 1, wherein the integrated strength ratio D/G (I₁₃₆₀/I₁₅₈₀) of a Raman D-line and G-line of the porous carbon-based material is in a range of about 0.1 to about 2.

21. A method of preparing a composite negative active material, the method comprising:
heat treating a mixture of a pore-forming material and a carbon precursor to form a composite of the pore-forming material and carbon;
etching the pore-forming material to form porous carbon having nanopores;
impregnating the porous carbon with a catalyst to form the porous carbon impregnated with the catalyst; and
introducing a metal precursor to the porous carbon impregnated with the catalyst to grow metal nanostructures in pores.

22. The method of claim 21, wherein the pore-forming material is silicon oxide.

23. The method of claim 21, wherein the carbon precursor is selected from the group consisting of petroleum-based pitch, coal-based pitch, polyimide, polybenzimidazole, polyacrylonitrile, mesophase pitch, furfuryl alcohol, furan, phenol, cellulose, sucrose, polyvinyl chloride, and a mixture thereof.

24. The method of claim 21, wherein the heat treatment in the forming of the composite of the pore-forming material and carbon is performed within a temperature range of about 800° C. to about 3000° C. under an inert gas atmosphere.

25. The method of claim 21, wherein the forming of the composite of the pore-forming material and carbon further comprises a graphitization-promoting catalyst including iron (Fe), aluminum (Al), cobalt (Co), or nickel (Ni).

26. The method of claim 21, wherein a diameter of the pore in the porous carbon is in a range of about 50 nm to about 300 nm.

27. The method of claim 21, wherein the catalyst is selected from the group consisting of Au, Ag, Ni, and Cu.

28. The method of claim 21, wherein the metal precursor comprises SiH₄ or SiCl₄.

29. The method of claim 21, wherein the growing of the metal nanostructures comprises a heat treating process within a temperature range of about 400° C. to about 500° C.

30. The method of claim 21, wherein at least a portion of the metal nanostructures is nanowires.

31. A lithium secondary battery comprising:
a positive electrode including a positive active material;
a negative electrode including a negative active material; and
an electrolyte disposed between the positive electrode and the negative electrode,
wherein the negative active material includes the composite negative active material of claim 1.
